(19) United States
(12) Patent Application Publication
(10) Pub. No.: US 2007/0083294 A1
(43) Pub. Date: Apr. 12, 2007

(54) Wireless data acquisition system

(76) Inventor: David A. Bruno, Portland, OR (US)

Correspondence Address: CHERNOFF, VILHAUER, MCCLUNG & STENZEL, 1600 ODS TOWER, 601 SW SECOND AVENUE, PORTLAND, OR, 97204-3157, US

(21) Appl. No.: 11/521,958

(22) Filed: Sep. 14, 2006

Related U.S. Application Data
(60) Provisional application No. 60/717,327, filed on Sep. 15, 2005.

(51) Int. Cl. G05D 11/00

(52) U.S. Cl. 700/295

(57) ABSTRACT

Data is acquired by a data acquisition unit and wirelessly transmitted to a data transfer device that wirelessly retransmits the data to a data processing device.

### CROSS-REFERENCE TO RELATED APPLICATIONS

This application claims the benefit of U.S. Provisional App. No. 60/717,327, filed Sep. 15, 2005.

### STATEMENT REGARDING FEDERALLY SPONSORED RESEARCH OR DEVELOPMENT

Not applicable.

### BACKGROUND OF THE INVENTION

The present invention relates to data processing systems and, more particularly, to a system for acquiring data with a remote sensor and communicating the data to a data processing device.

Building management systems can substantially reduce the cost and risk of operating a building or other facility by monitoring and/or controlling the operation of a number of building systems. For example, an energy management system may be used to allocate energy usage to individual occupants of a facility or curtail energy usage for certain activities during periods of high consumption or price. Similarly, a building automation system may monitor the local temperature and relative humidity at several locations in a facility to determine whether the heating and air conditioning system is operating correctly and may actuate fans or other controls to regulate environmental conditions. While the potential savings are significant, the savings are limited and an economic analysis comparing the potential savings with the cost of installing and operating the system often provides the primary justification for installing a building management system and, if a system is installed, often dictates or substantially impacts the design of the system.

Building management systems typically comprise data acquisition, communication, analysis and control sub-systems. Data is typically acquired by quantifying measurement parameters with a plurality of geographically distributed sensors, converting the measurement data to electrical signals, and transmitting the signals to a building management computer that is remote from the sensors. A building management application running on the computer may store, analyze and display the data encoded in the signals and may use the data to formulate instructions for controlling automated equipment. The data acquisition and communication subsystems comprise major elements of the cost of a building management system because real time data acquisition and communication equipment can be expensive to acquire and install and because effective building management systems commonly require data from large numbers of sensors that are widely distributed geographically in a building or facility. As a consequence, a building management system may be determined to be economically infeasible or the system's performance may be compromised because the number and geographical scope of the sensors of the data acquisition subsystem is limited for economic reasons.

For example, both wired and wireless communication systems have been used in conjunction with building management systems. The cost of installing a wired communication system can be substantial and in some cases prohibitive. In existing facilities it is commonly necessary to open walls or fish wires through walls containing plumbing and electrical wiring and even in new construction the cost of installing wiring in walls can be significant. In addition, drilling holes in floors and roofs and digging trenches in paved or landscaped areas is often necessary to connect a remotely located sensor to the computer that will process the data acquired by the sensor. Moreover, once a wired communication system is installed it is often expensive and difficult to make changes to the system as required by changes in the facility's occupancy.

Many of the physical problems and costs incurred in installing a wired network of remote sensors can be avoided with a wireless communication system. Typically, each node of the system includes a radio frequency transceiver that can communicate with a transceiver of at least one other network node. Many wireless data processing networks rely on a limited number of access points with all nodes of the network communicating directly with an access point. While the communication protocol is relatively simple, all nodes must be within range of an access point which may not be possible because of the remoteness of the sensors of a building management system and interference produced by the building's structure or occupancy.

Mesh networks provide an alternative to the access point centric architecture. In a mesh network, data is communicated from node-to-node enabling a plurality of transceivers with limited range to serve a geographically dispersed sensor network. In some networks, the sender of a message determines, from a table specifying one or more paths though the network, the addresses of all nodes between the sender and the ultimate destination and includes the addresses in the message header. When the message is received by a neighboring node, the neighbor finds the address of the next node in the message header and transmits the message to that node. In other systems, the sender includes only the address of the ultimate destination in the message. The receiver of the message looks up the address of a next node in a table of nodes specifying paths though the network to the ultimate destination and inserts the address of a next node for one of these paths into the message before transmitting the message to the next node in the mesh. The process is repeated and the message is relayed from node to node until the message reaches the ultimate destination. While wireless communication systems avoid many of the physical problems and much of the installation costs of a wired network of remote sensors, the installation cost savings may be substantially offset by the cost of the hardware used to implement a wireless data communication system.

Moreover, the computer networking technology and hardware developed for typical data processing applications generally has capabilities substantially greater than required for many of the data acquisition activities of a building management system or other real time data processing system. Typically, real time data acquisition devices used in data processing applications utilize high sampling rates and require an active, bidirectional connection to a computer whenever data is being collected. The communication system must have sufficient bandwidth handle the nearly continuous communications between the computer and the sensors and the transceivers of wireless data processing networks are typically capable of transmitting large quantities of data at high rates and often include substantial data processing capabilities to enable operation within complex communication protocols. On the other hand, the data utilized by a building management system often changes very slowly or infrequently with time. For example, the temperature in a portion of a facility may change by a few degrees in an hour or the state of a light switch may remain unchanged for many hours. The cost of a data acquisition network comprising a large number of sensors, individually connected to a typical spread spectrum network transceiver capable of transmitting millions of bits of data per second, is likely to be prohibitively high and, while several geographically proximate sensors may be wired to a single network transceiver, this solution may not be practical or economically viable because of the wide geographical distribution of sensors used in building management systems.

What is desired, therefore, is a data acquisition and communication system enabling an economical, widely distributed network of sensors for use with a building management system or other real time data processing system.

### BRIEF DESCRIPTION OF THE DRAWINGS

FIG. 1 is a block diagram of an exemplary data processing system including a wireless data acquisition system and a mesh data communication network.

FIG. 2 is a block diagram of an exemplary data processing system including a wireless data acquisition system and a data communication network having a star topology.

FIG. 3 is a block diagram of an exemplary building management computer.

FIG. 4 is a block diagram of an exemplary network node device for a wireless data communication network.

FIG. 5 is a block diagram of an exemplary data transfer unit for a wireless data acquisition system.

FIG. 6 is a block diagram of an exemplary data acquisition unit for a wireless data acquisition system.

FIG. 7 is a block diagram of an exemplary transmission from a data acquisition unit to a data transfer unit of a wireless data acquisition system.

### DETAILED DESCRIPTION OF PREFERRED EMBODIMENT(S)

Building management systems are commonly used to manage and automate the operation of building systems. For examples, a building management system may be used to control a heating and air conditioning system or to manage the facility's energy usage by allocating energy usage to individual occupants of the facility. A decision to incorporate a building management system in an existing facility or a new facility is typically determined by an economic analysis in which the cost of installing and operating the system is compared to the expected savings and improved occupancy rate. Since the economic gain through energy savings, reduced risk, and improved occupant satisfaction is limited, the cost of installing and operating a building management system must be minimized to provide economic justification for installing the system.

A building management system typically comprises a data processing device that receives data acquired by a plurality of remotely located sensors sampling conditions at number of locations in the facility, analyzes the sensor data, and outputs information about the facility's operation and/or control signals to automated equipment of one of the building's systems. Due in large part to the wide geographical distribution of the building management system's elements, data acquisition and communication represents a substantial part of the cost of a building management system. Installation costs can be high for a hard wired communication link between a plurality of remotely located sensors and a central data processor because wiring must be installed between floors and fished through walls of the facility. Wireless communication networks avoid much of the installation costs of hard wired communication links, but the higher cost of wireless communication devices often substantially offsets the installation cost savings.

In addition, data acquisition and communication systems developed for general data processing usage commonly have capabilities exceeding the needs of a building management system and other real time data processing systems. For example, an energy management system may utilize the states of light switches which may remain unchanged for many hours and may only change a few times during a day to determine energy usage at various locations in the facility or an automated heating and air conditioning system may utilize local temperatures sensed at intervals of several minutes at a number of locations to control fans or dampers. Data acquisition systems developed for general data processing applications typically utilize high sampling rates and require a communication system with a high bandwidth to provide an active, bidirectional connection to the computer when the sensor is collecting data. Since implementation of a building management system is largely the result of an economic analysis of cost versus expected savings, the cost of the data acquisition and communication subsystems may make a building management system economically infeasible or may cause the performance of a system to be compromised by reducing the numbers and locations of devices acquiring data for the system. The inventors concluded that the cost of the data acquisition and communication subsystems is a substantial obstacle to the adoption of building management systems and that opportunities presented by building management systems can be exploited by a wireless data acquisition and communication system that is simpler, less expensive, and better suited to the requirements of a building management system.

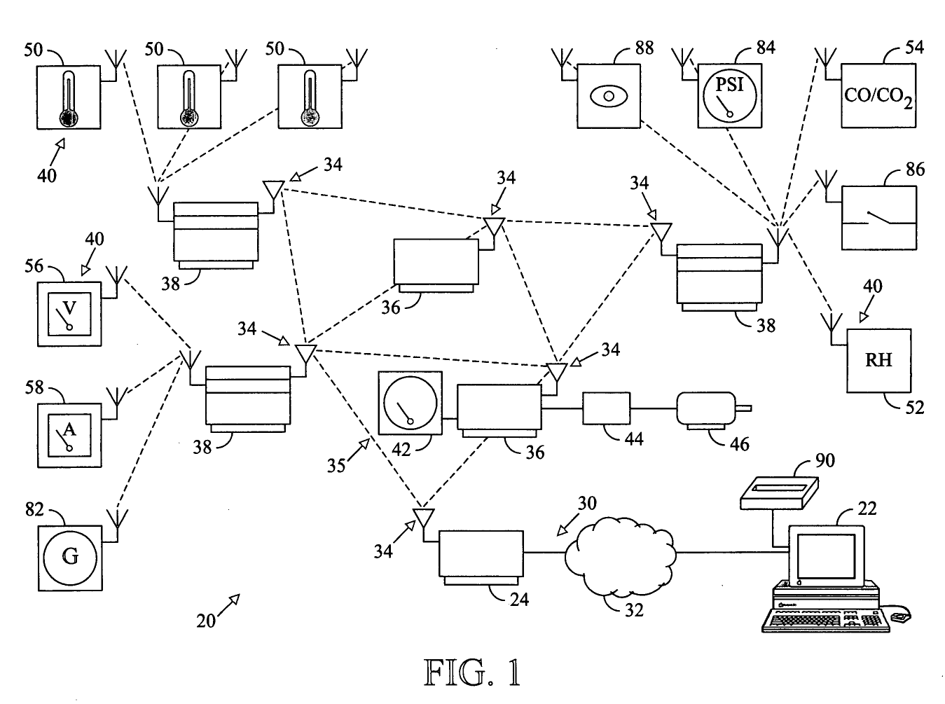

Referring in detail to the drawings where similar parts are identified by like reference numerals and referring, in particular, to FIG. 1, a building management system 20 typically comprises a building management computer 22 that typically includes one or more building automation, energy management and other building management application programs. The building management applications typically utilize data related to conditions at a number of locations in the building or facility to perform building management functions and formulate operating instructions for automated building equipment.

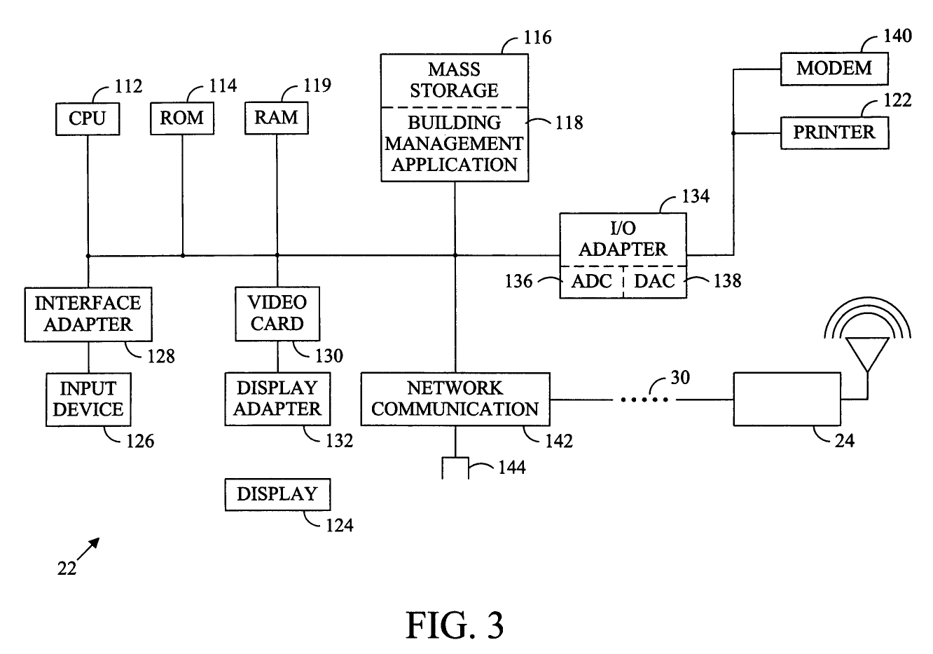

Referring to FIG. 3, the building management computer 22 typically comprises a microprocessor-based, central processing unit (CPU) 112 that fetches data and instructions, processes the data according to the instructions, and stores the results or transmits the results to an output device or another data processing device. Typically, basic operating instructions used by the CPU 112 are stored in nonvolatile memory or storage, such as a flash memory or read only memory (ROM) 114. Instructions and data used by application programs, including a building management program 118, are typically stored in a nonvolatile mass storage or memory 116, such as a disk storage unit or a flash memory. The data and instructions may be transferred from the mass storage 116 to a random access memory (RAM) 119 and fetched from RAM by the CPU 112 during execution. Data and instructions are typically transferred between the CPU, ROM, RAM, and mass storage over a system bus 120.

The building management computer 22 may also include a plurality of attached devices or peripherals, including a printer 122, a display 124, and one or more user input devices 126, such as a keyboard, mouse, or touch screen. Under the control of the CPU 112, data is transmitted to and received from each of the attached devices over a communication channel connected to the system bus 120. Typically, each device is attached to the system bus by way of an adapter, such as the interface adapter 128 providing an interface between the input device 126 and the system bus. Likewise, a display adapter 132 provides the interface between the display 124 and a video card 130 that processes video data under the control of the CPU. The printer 122 and similar peripheral devices are typically connected to the system bus 120 by one or more input-output (I/O) adapters 134. The building management computer also commonly includes facilities for communicating with other data processing devices. These facilities may include a network connection 142 and communication device or port 144 enabling communication over wide area network (WAN) or a local area network (LAN) and one or more modems 140 for communication over a telephone system or another communications link, including the Internet 30. The building management computer 22 of the building management system 20 is also connected to a server transceiver 24 by a communication link 30, such as a local area network (LAN) and which may include the Internet 32.

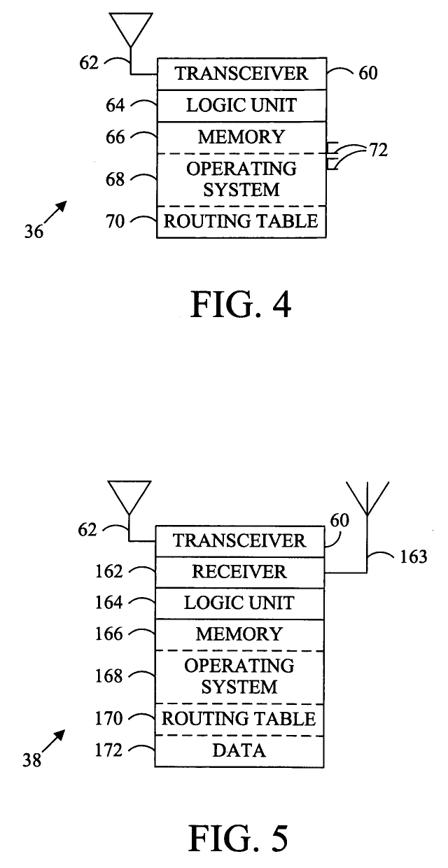

In the building management system 20, the server transceiver 24 communicates wirelessly with one and preferably more than one transceiver comprising the nodes 34 of a mesh data communication network 35 in which messages are relayed from node to node over a communication path leading from the originator of a message to the message's ultimate recipient. Referring to FIGS. 4 and 5, respectively, a network node 34 comprises a network node transceiver 60 that may be included in a stand alone network node device 36 or may be incorporated in or connected to a data transfer unit 38 that wirelessly receives data from one or more data acquisition units 40 for retransmission to the building management computer 22. A network node 34; including nodes comprising the server transceiver 24, network node devices 36 and data transfer units 38; typically comprises a FM radio network node transceiver 60 having an antenna 62, a logic unit 64 and a memory 66. Radio transmissions are commonly 900 MHz, spread spectrum transmissions, in the unlicensed Instrument, Scientific and Medical (ISM) band, but transmissions can be at any convenient frequency and may utilize other transmission protocols. The power of transmitters operating in the ISM band is limited, limiting the range of the transceivers to approximately 1500 feet. However, this range can be significantly reduced by a number of environmental factors such as the location of a transceiver relative to significant structures, such as components of the building's framework, or occupancy activities, such as operating machinery. Since the various devices of a building management system are typically widely disbursed throughout the facility and interference resulting from the presence of structures and occupancy activities is likely, a transceiver with power limitations is often unable to communicate with all of the other transceivers of the communication network. In a mesh communication network, messages are relayed from node to node enabling communication over a large area, even though the ranges of the individual transceivers are limited.

A node of the mesh network 20, typically includes basic operating instructions or an operating system 68 for controlling the logic unit 66 and a routing table 70 that is stored in the memory 64 and contains ordered listings of the identities of the nodes making up one or more communication paths between the respective node and the other nodes of the network, including the server transceiver 24. In some mesh communication networks, the originator of a query or other message looks up the identities of all nodes between the originator and the ultimate destination of the message in the routing table and includes the identities of all nodes in a communication path in a header for the message. When a transceiver at a node receives a message, the identity of the next node is determined from the message header and the message is transmitted to that node. In other mesh communication networks, only the identity of the ultimate destination is included in the message and when the message is received by a node the logic unit for the node selects a next immediate node to receive the message from the routing table and addresses the message to that node. Transceivers comprising nodes of a mesh network typically can communicate by either broadcasting a message to all other devices in range or with a sender-recipient technique in which one node initiates transactions or queries of another node and the receiving node acknowledges the receipt of the message and responds to the query by supplying the data or taking the action requested in the query. The server transceiver 24 is communicatively connected to the building management computer 22 and receives data from the network of node transceivers and transfers the data to the building management computer and transmits instructions and other data received from the building management computer to the network node transceivers.

In addition to network data communications, a network node device 36 may also be connected to communicate with one or more sensors 42, such as a power meter, or an output device, such as a controller 44 for a motor 46 or other automated equipment operated by the building management system. Communications with these sensors and other output devices is through wired communication links connected to one or more ports 72 of the network node device 36.

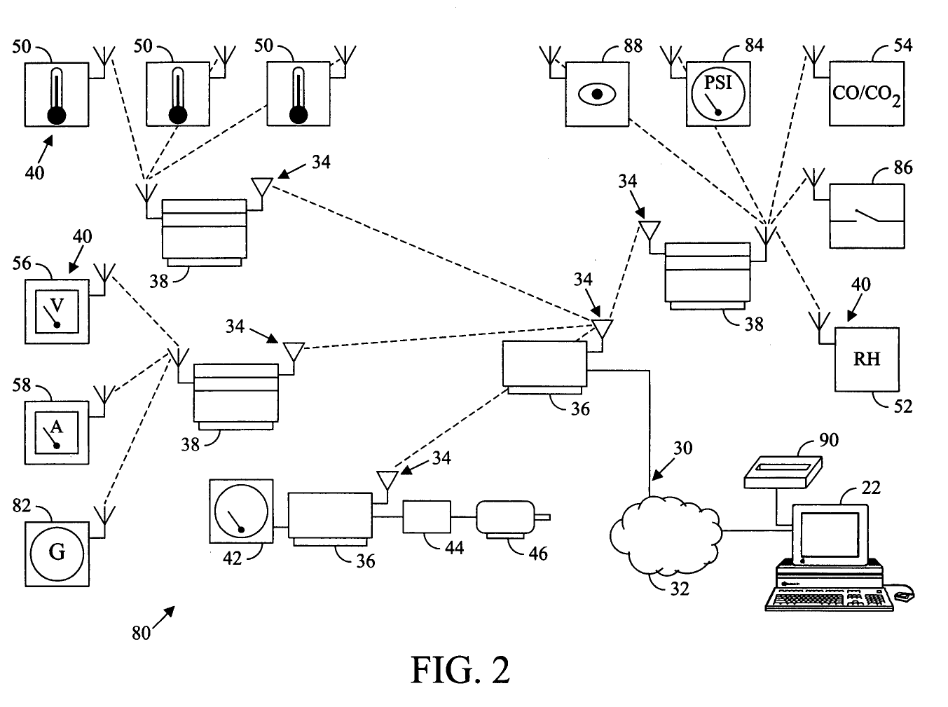

While the mesh data communication network 35 enables communication over long distances with relatively low power network node transceivers, the communication protocol is relatively complex requiring storage of the identities of a number of nodes making up each of a plurality of communication paths to each potential message destination and a logic unit to select the most appropriate path for each message. Referring to FIG. 2, alternatively a building management system 80 may utilize a star network topology where all of the nodes 34 of the network communicate directly with the server transceiver 24 which is communicatively connected to the building management computer 22. Communications initiated by the building management computer are either broadcast to all network nodes 34 or addressed to a single node and all communications from remote nodes are directed to the server transceiver substantially reducing the complexity of the communications and the devices making up the network nodes. For example, the routing table 70 of a remote node need only contain the address of the server transceiver and the logic unit is not required to select a communication path from a plurality of potential paths through the communication network.

Data used by the building management system 20, 80 may be obtained by sensors 42 connected directly to network node devices 36 and under the direct control of the building management computer. However, such sensors are commonly capable of sampling the measurement parameter at rates in excess of the requirements of many of the functions of a building management system or other real time data processing system. In addition, these sensors typically are controlled by the system's computer and require a communication system with substantial bandwidth to enable frequent two way communication between the building management computer and the sensors.

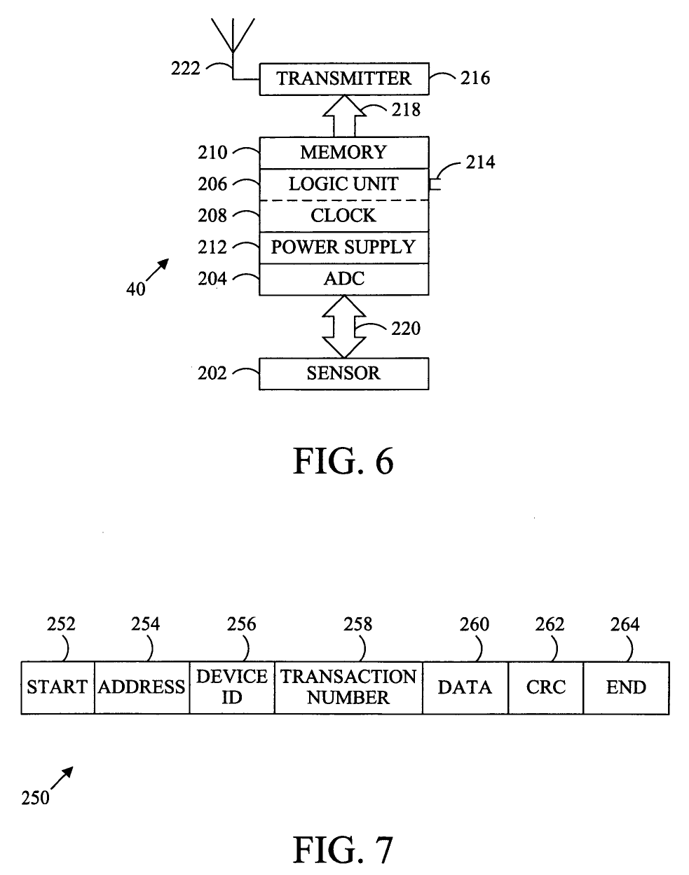

In the building management systems 20 and 80, data is also acquired by a plurality of data acquisition units 40 which, in a typical building management system, are located in a number of geographically disparate locations throughout a facility as required by the data needs of the building management system. For example, a building management system monitoring the operation of a heating and air conditioning system may include a temperature sensor in each of plurality of zones on each floor of the building or in each enclosed area within the building. Referring to FIG. 6, the data acquisition units 40 include at least one sensor 202 for quantifying a measurement parameter. Data acquisition units of building management systems are commonly used to acquire data related to local environmental conditions and include sensors for measuring, for example, temperature 50, relative humidity 52, air quality 54, such as carbon monoxide and carbon dioxide levels. Energy consumption may be determined with sensors that measure, for example, voltage 56, current 58, power, gas flow 82, and pressure 84. Data acquisition units may also include sensors for detecting the occurrence of events or the states of devices, such as the actuation state of a relay or a switch 86, the operation of a motor or the presence of a source of heat 88, such as a fire or the body heat of the occupants of a space. At specified intervals, upon the occurrence of an event or at other times, the data acquisition units 40 quantify at least one measurement parameter at the output of the sensor 202, convert the quantity data to a signal useful for transmission to the building management computer and transmit a signal representing the data to a data transfer device 38 for retransmission by a communication network node transceiver.

The value of the measured parameter may be obtained by periodically sampling the output or by detecting a change in the state of the output of a sensor 202 that is connected to or incorporated within the data acquisition unit 40. The data acquisition unit 40 typically includes an analog-to-digital converter (ADC) 204 to convert the analog output of the sensor to digital data suitable for use by the building management computer. The data acquisition unit also includes a logic unit 206, preferably including a clock 208, and a memory 210 for storing data and instructions for the operation of the data acquisition unit. A power supply 212 that may be connected to the building's electrical system or may comprise a battery or other energy source, such as a solar cell, that is independent of the building's utilities, provides power for operating the data acquisition unit.

Instructions for operating the data acquisition unit are typically input to the memory 210 through a port 214 connectable to another data processing device, such as the building management computer 22. The connection to the port 214 may be made with a cable or through a docking station 90 attached the data processing device that is downloading the instructions to the data acquisition unit. The instructions typically include measurement instructions that direct the logic unit's communication with the sensor and may, by way of examples, direct the logic unit 206 to sample the output of the sensor periodically, record a change in the output of the sensor or record the output of the sensor in response to an occurrence of an event. The instructions also preferably direct the logic unit 206 to associate and store a time stamp, generated in conjunction with the clock 208, with values of the measurement parameter obtained from the sensor by the logic unit to indicate the time at which the quantification of the measurement parameter occurred. Transmission instructions are also stored in the memory 210 and typically include, by way of examples, the address or other identity of the data transfer device that is to receive the data acquired by the data acquisition unit and the period or event that is to trigger transmission of data by the data acquisition unit. For example, the data acquisition unit may accumulate a plurality of values of the measurement parameters in the memory 210 before periodically transmitting the data to the data transfer unit or may transmit the data during a transmission slot following the occurrence of an event such as a change of state of monitored switch or other device. The memory also typically includes basic operating instructions for the operation of the logic unit 206.

The data acquisition unit 40 also includes a radio frequency, wireless, data acquisition unit transmitter 216 that is communicatively connected to and controlled by the logic unit 206. The transmitter, including an antenna 222, and other elements of the data acquisition unit 40 may be may be incorporated in a single unit or may comprise separate modules that are connected by communication links 218, 220.

The data acquisition unit transmitter 216 transmits the sensor data acquired by the data acquisition unit to a receiver 162 of a data transfer unit 38 that is communicatively connected to the building management computer 22 through the network node transceiver 60 and the data communication network 20, 80. Since real time data acquisition from many of the sensors used in a building management system or other similar real time data processing system is often limited, the bandwidth required for transferring the data from a data acquisition unit 40 to a data transfer unit 38 is substantially less than the bandwidth required by the data network communications of the building management system. The transmission protocol and frequency for transmissions from the data acquisition units is preferably different from the protocol and frequency utilized for network transmissions. While other modulation techniques could be used, to reduce the cost of data acquisition and enable networks of less expensive sensors, the transmitter 216 of the data acquisition unit preferably utilizes “on-off shift keying” (OOSK), amplitude modulation (AM) also referred to as “on-off keying” (OOK) or “carrier-present carrier-absent” (CPCA) modulation. The OOSK modulation source has two states: “on” and “off”, and the logic values of data are represented by transmitting at respective maximum and minimum amplitudes of the carrier signal. Preferably, transmissions by the data acquisition units are at frequencies within the 260-470 MHz band and, more preferably, at 418 MHz. Regulatory restrictions for this band limit output power, bandwidth, and harmonic emissions. In addition, transmissions are limited to control or command signals, identification codes, emergency radio control signals and variable data, if a control or indentification is transmitted with the data. Transmission periods are limited to five (5) seconds following activation for automatic transmissions and periodic transmitters are limited to transmissions of one second followed by a silent period at least 30 times the duration of the transmission but not less than 10 seconds in duration. As result, the 260-470 MHz band is relatively free of interference and provides a reliable communications link for low bandwidth data transmissions.

Referring to FIG. 5, a data transfer unit 38 for data acquisition and communication in the building management systems 20, 80 comprises a receiver 162, including an antenna 163, to receive the 418 MHz, AM transmissions from the data acquisition units that are associated with the data transfer unit. Data addressed to a data transfer unit is received by the receiver 162, processed by a logic unit 164 according to instructions contained in a memory 166 and retransmitted by the network node transceiver 60. To reduce network communications, the logic unit 164 may store data 172 received from one or more data acquisition units, including related transaction identifiers, time stamps and data acquisition unit identities, in the memory 166 before initiating a transmission by the network node transceiver 60.

Referring to FIG. 7, a preferred transmission 250 from a data acquisition unit to a data transfer unit includes a start sequence 252 to identify the beginning of the transmission; an address 254 identifying the data transfer unit that is to receive the transmission; a device identification 256 identifying the data acquisition unit that is transmitting; a transaction number 258 that is incremented for each subsequent transmission; the measurement parameter data 260 captured from the sensor, including related time stamp data; error checking or correction data 262, such as a cyclic redundancy check (CRC) enabling the logic unit 164 of the data transfer unit to determine whether the data was transmitted correctly and, in some cases, to correct errors in the data; and an ending sequence 264.

The logic unit 164 of the data transfer unit 38 may determine that transmissions from a data acquisition unit have been interrupted by comparing the current time to a time stamp, stored in the memory, for the last transmission received from the data acquisition device. Missing transmissions may be detected by determining that the transaction number of a current transmission has not incremented correctly when compared to the transaction number for a prior transmission from the respective data acquisition unit which is stored in the memory. In addition, the logic unit 164 of the data transfer unit preferably monitors the strength of transmissions from the various data acquisition units associated with the data transfer unit to determine if service, relocation or an intervening signal repeater is necessary. If transmissions are not received from a particular data acquisition unit or if data is corrupted during transmission, the logic unit of the data transfer device may send an error message to the building management computer 22 indicating that the data acquisition unit may require service, relocation or other action.

To transmit the data to the building management computer 22, the logic unit 164 obtains the address for a message from a routing table or other address table 170 included in the data transfer unit memory 166, inserts the data from the data acquisition unit(s) into the message and transmits the message to the server transceiver 24 and the building management computer 22 utilizing the network communication protocol in use with the data communication network.

The data acquisition system substantially reduces the cost of acquiring data from a plurality of remote sensors making building management systems and other real time data processing systems utilizing widely distributed networks of sensors more practical and economically justifiable.

The detailed description, above, sets forth numerous specific details to provide a thorough understanding of the present invention. However, those skilled in the art will appreciate that the present invention may be practiced without these specific details. In other instances, well known methods, procedures, components, and circuitry have not been described in detail to avoid obscuring the present invention.

All the references cited herein are incorporated by reference.

The terms and expressions that have been employed in the foregoing specification are used as terms of description and not of limitation, and there is no intention, in the use of such terms and expressions, of excluding equivalents of the features shown and described or portions thereof, it being recognized that the scope of the invention is defined and limited only by the claims that follow.

The invention claimed is:

1. A data acquisition apparatus for a data processing system, said data acquisition apparatus comprising:
(a) a sensor for detecting a measurement parameter;
(b) a memory storing a measurement instruction, a storage instruction and a transmission instruction;
(c) a logic unit quantifying a value of said measurement parameter detected by said sensor according to said measurement instruction and storing said value of said measurement parameter in said memory according to said storage instruction; and
(d) a radio frequency transmitter to transmit said value of said measurement parameter to said data processing system in response to execution of said transmission instruction by said logic unit.

2. The data acquisition apparatus of claim 1 further comprises a clock generating a time datum associated with said with said value of said measurement parameter by said logic unit according to a time stamp instruction.

3. The data acquisition apparatus of claim 1 wherein said measurement parameter comprises a state of a device and said measurement instruction causes said logic unit to record a change in said state detected by said sensor.

4. The data acquisition apparatus of claim 1 wherein said radio frequency transmitter transmits said value of said measurement parameter by amplitude modulation.

5. The data acquisition apparatus of claim 1 wherein logic unit associates a transaction identification with a transmission to said data processing system.

6. A system for acquiring and communicating data to a data processing system comprising:
(a) a data acquisition unit including:
(i) a sensor for detecting a measurement parameter;
(ii) a memory storing a measurement instruction, a storage instruction, and a transmission instruction;
(iii) a logic unit quantifying a value of said measurement parameter detected by said sensor according to said measurement instruction and storing said value of said measurement parameter in said memory according to said storage instruction; and
(iv) a transmitter to transmit said value of said measurement parameter in response to execution of said transmission instruction by said logic unit; and
(b) a data transfer unit including:
(i) a receiver to receive said transmission of said value of said measurement parameter; and
(ii) a network transceiver to retransmit said measurement parameter value to data processing device.

7. The data acquisition apparatus of claim 6 further comprises a clock generating a time datum associated with said with said value of said measurement parameter by said logic unit according to a time stamp instruction.

8. The data acquisition apparatus of claim 6 wherein said measurement parameter comprises a state of a device and said measurement instruction causes said logic unit to record a change in said state detected by said sensor.

9. The data acquisition system of claim 6 wherein said transmitter of said data acquisition unit transmits said measurement parameter value at a different frequency than a transmission frequency used by said transceiver to transmit said measurement parameter value to said data processing device.

10. The data acquisition system of claim 9 wherein said transmitter transmits said measurement parameter value at a frequency of 418 megahertz.

11. The data acquisition system of claim 6 wherein said transmitter of said data acquisition device transmits said measurement parameter with a modulation method that differs from the modulation method of said transceiver.

12. The data acquisition system of claim 5 wherein said transmitter transmits said value of said measurement parameter with amplitude modulation.

13. The data acquisition system of claim 11 wherein said transmitter transmits said value of said measurement parameter with on-off shift keying modulation.

14. The data acquisition system of claim 6 wherein said data transfer unit further comprises a data transfer logic unit and a data transfer unit memory, said data transfer logic unit storing values of measurement parameters included in a plurality of transmissions in said data transfer memory.

15. The data acquisition system of claim 14 wherein a plurality of measurement parameters stored in said data transfer unit memory are transmitted by said network transceiver in a single transmission to said data processing system.

16. The data acquisition system of claim 6 wherein said data transfer unit further comprises a data transfer logic unit and a data transfer unit memory, said data transfer logic unit transmitting a notification to said data processing unit if a transmission including a data acquisition unit identification stored in said data transfer memory is not received in accordance with a transmission schedule stored in said data acquisition unit memory.

17. The data acquisition system of claim 16 wherein said data transfer logic unit causes said network transceiver to transmit a notification to said data processing unit if a signal strength for a transmission from a data acquisition unit is not at least equal to a minimum signal strength.

18. The data acquisition system of claim 6 wherein said data transfer unit further comprises a data transfer logic unit and a data transfer unit memory, said data transfer logic unit transmitting a notification to said data processing unit if a transaction number included in a transmission from a data acquisition unit is incremental to a transaction number stored in said data transfer unit memory.

19. A method of acquiring data for a data processing system, said method comprising the steps of:
(a) quantifying a value of a measurement parameter;
(b) wirelessly transmitting said value of said measurement parameter to a data transfer unit; and
(c) wirelessly retransmitting said value of said measurement parameter to a data processing device.

20. The method of acquiring data of claim 19 wherein said wireless transmission of said value of said measurement parameter to a data transfer unit is performed by amplitude modulation.
